(19) United States
(12) Patent Application Publication
(10) Pub. No.: US 2008/0204606 A1
(43) Pub. Date: Aug. 28, 2008

(54) ELECTRONIC EQUIPMENT AND SEMICONDUCTOR DEVICE

(75) Inventor: Shinichi Idomukai, Chiba-shi (JP)

Correspondence Address: BRINKS HOFER GILSON & LIONE, P.O. BOX 10395, CHICAGO, IL, 60610, US

(73) Assignee: Seiko Instruments Inc., Chiba-shi (JP)

(21) Appl. No.: 12/043,738

(22) Filed: Mar. 6, 2008

(30) Foreign Application Priority Data
Dec. 26, 2006 (JP) 2006-348990

(51) Int. Cl. H04N 5/44

(52) U.S. Cl. 348/734; 348/E05.096

(57) ABSTRACT

Provided is an electronic device which consumes less power in a standby state waiting for a signal sent from a remote controller. A photodiode (22) receives a signal from a remote controller (10) to generate a current based on the signal. A microcontroller control chip (23) recognizes a header part of the signal based on the current generated by the photodiode (22) using a decode processing circuit to output an activation signal for activating a microcontroller (24) whose power is cut off. The microcontroller (24) is activated from a state where its power is cut off based on the activation signal.

### REFERENCE TO THE RELATED APPLICATIONS

This application claims priority under 35 U.S.C. §119 to Japanese Patent Application No. JP2006-348990 filed Dec. 26, 2006, the entire content of which is hereby incorporated by reference.

### TECHNICAL FIELD

The present invention relates to an electronic device for receiving a signal from a remote controller, and a semiconductor device mounted on the electronic device.

### BACKGROUND ART

Currently, a remote controller capable of remotely controlling electronic devices such as a television device and an audio device is normally attached to the electronic devices. FIG. 2 is a schematic diagram showing a conventional electronic device.

An electronic device 40 for receiving a signal from a remote controller 30 includes a microcontroller 43 for controlling the device.

When the electronic device 40 in a standby state with the microcontroller 43 being in a low-power consumption mode, waiting for a signal from the remote controller 30, receives a signal from the remote controller 30, the microcontroller 43 decodes the signal. Then, the microcontroller 43 is shifted from the low-power consumption mode to a normal active mode, and the electronic device 40 is shifted from the standby state to a normal active state.

Consequently, power consumption of the electronic device 40 in the standby state is reduced.

In order to reduce power consumption of electronic devices, there is proposed a technology of providing the circuit block which operates in low-power consumption, separately from the microcontroller (see, for example, JP 2003-084871 A). According to the technology, the circuit counts time, and after the elapse of a predetermined time, the microcontroller is activated from the state where power is cut off.

However, in the conventional technology, for decoding a signal which is unknown when to be received, the microcontroller 43 always needs to be in a standby state while consuming power to receive a signal at any time. As a result, the power of the microcontroller 43 is not completely cut off, which causes extra power consumption in the electronic device 40.

The present invention has been made to solve the above problem, and an object of the present invention is to provide an electronic device which consumes less power in a standby state of waiting for a signal from a remote controller.

### SUMMARY OF THE INVENTION

In order to solve the above problem, the present invention provides an electronic device for receiving a signal from a remote controller, including: a current generating device; a microcontroller control chip; and a microcontroller, the current generating device receiving the signal from the remote controller to generate a current based on the signal, the microcontroller control chip recognizing, based on the current generated by the current generating device, a part of the signal using a decode processing circuit to output an activation signal for activating a microcontroller whose power is cut off, the microcontroller being activated from a state where the power thereof is cut off based on the activation signal.

The present invention also provides a semiconductor device mounted on an electronic device for receiving a signal from a remote controller, including: signal recognition means for recognizing, based on a current generated by a current generating device which receives the signal from the remote controller to generate a current based on the signal, a part of the signal using a decode processing circuit; and activation signal output means for outputting an activation signal for activating a microcontroller whose power is cut off, after the recognition by the signal recognition means.

In the present invention, when the electronic device receives a signal from the remote controller, the microcontroller is activated from the state where the power is cut off, and when the electronic device is in the standby state and does not receive a signal from the remote controller, the power of the microcontroller is cut off. Accordingly, the electronic device in the standby state consumes less power.

### BRIEF DESCRIPTION OF THE DRAWINGS

FIG. 1 shows a schematic diagram showing an electronic device.

FIG. 2 shows a schematic diagram showing a conventional electronic device.

### DETAILED DESCRIPTION OF THE PREFERRED EMBODIMENTS

Hereinafter, an embodiment of the present invention is described in detail with reference to the drawings.

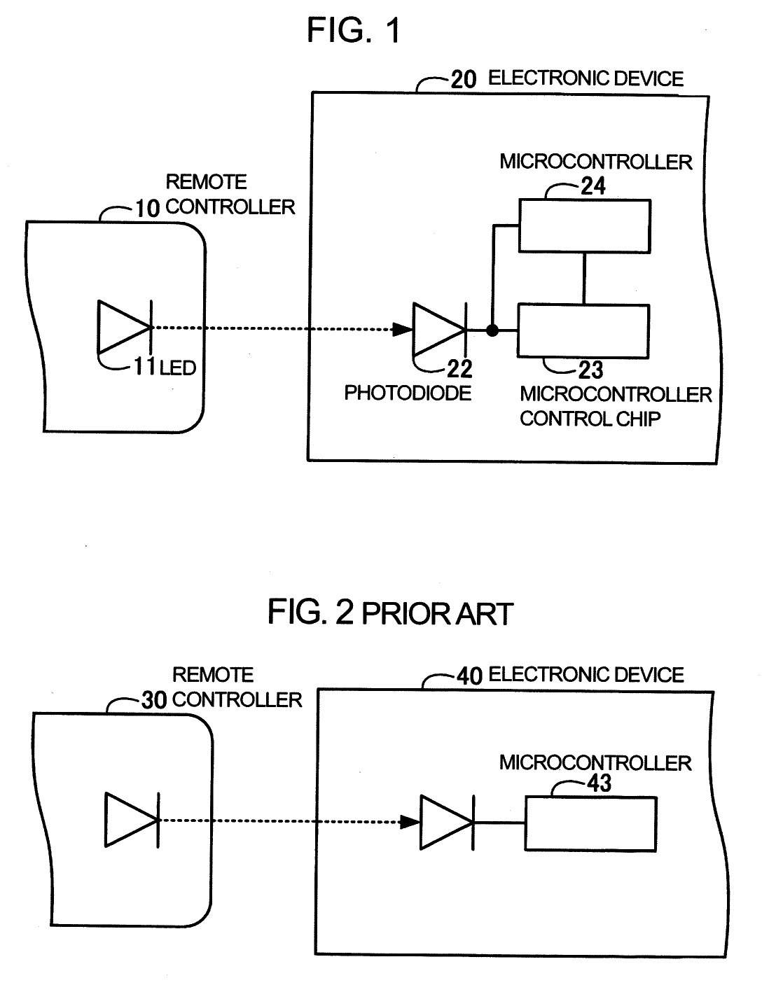

First, a description is given of a structure of an electronic device. FIG. 1 is a diagram showing the electronic device.

A remote controller 10 includes a light-emitting diode 11 and is capable of conducting wireless communication with an electronic device 20 such as a television device and an audio device. The electronic device 20 includes a photodiode 22 for wirelessly communicating with the remote controller 10 using the light-emitting diode 11, a microcontroller 24 for controlling the electronic device, and a microcontroller control chip 23 for controlling the microcontroller 24. The microcontroller 24 is connected with the photodiode 22 via the microcontroller control chip 23, and further directly connected to the photodiode 22. Further, the microcontroller control chip 23 and the microcontroller 24 each include decode processing circuit (not shown) for recognizing a signal sent from the remote controller 10.

In this case, the microcontroller control chip 23 includes a decode processing circuit (signal recognition means) and an activation signal output means (not shown). The decode processing circuit recognizes, based on a current generated by the photodiode 22, a part of a signal sent from the remote controller 10, and after the recognition, the activation signal output means outputs an activation signal for activating the microcontroller 24 whose power is cut off.

Next, a description is given of an operation when the electronic device 20 is activated from the state where power is cut off, by remote control by the remote controller 10.

Now, it is assumed that the electronic device 20 in a standby state is waiting for a signal sent from the remote controller 10, and the power of the microcontroller 24 is cut off. After that, the electronic device 20 receives a signal from the light-emitting diode 11 of the remote controller 10, and the photodiode 22 generates a current based on the signal. Based on the current, the microcontroller control chip 23 recognizes a header part of the signal by means of the decode processing circuit, and then, outputs an activation signal for activating the microcontroller 24 whose power is cut off. For example, when a chip for supplying power to the microcontroller 24 is operated by the activation signal, the microcontroller 24 is activated from the state where its power is cut off, and the electronic device 20 is shifted from the standby state to a normal active state. When the activated microcontroller 20 decodes a part other than the header part of the signal sent from the remote controller 10 using the decode processing circuit, the electronic device 20 completely decodes the signal sent from the remote controller 10.

Through such an operation, when the electronic device 20 receives a signal from the remote controller 10, the microcontroller 20 is activated from the state where its power is cut off, whereas when the electronic device 20 is in a standby state and does not receive a signal sent from the remote controller 10, the power of the microcontroller 20 is cut off. Accordingly, power consumption of the electronic device 20 in the standby state can be reduced.

Further, the decode processing circuit of the microcontroller control chip 23 does not completely decode the signal sent from the remote controller 10 but recognizes only the header part of the signal sent from the remote controller 10, which leads to a simplification of the circuit. As a result, the microcontroller control chip 23 is reduced in circuit size, and thus can be operated with less power consumption.

Equipped with a real time clock circuit (not shown) for supplying a clock signal in real time, the microcontroller control chip 23 is operated constantly.

Further, the microcontroller control chip 23 recognizes the header part of the signal sent from the remote controller 10, but may be made to recognize other predetermined part thereof.

Further, the photodiode 22 is mounted on the electronic device 20, but a phototransistor for converting light energy into electric energy may be mounted thereon.

1. An electronic device for receiving a signal from a remote controller, comprising:
a current generating device;
a microcontroller control chip; and
a microcontroller,
the current generating device receiving the signal from the remote controller to generate a current based on the signal,
the microcontroller control chip recognizing, based on the current generated by the current generating device, a part of the signal using a decode processing circuit to output an activation signal for activating a microcontroller whose power is cut off,
the microcontroller being activated from a state where the power thereof is cut off based on the activation signal.

2. An electronic device according to claim 1, wherein the microcontroller control chip recognizes a header part of the signal using the decode processing circuit.

3. An electronic device according to claim 1, wherein the current generating device comprises one of a photodiode and a phototransistor.

4. A semiconductor device mounted on an electronic device for receiving a signal from a remote controller, comprising:
signal recognition means for recognizing, based on a current generated by a current generating device which receives the signal from the remote controller to generate a current based on the signal, a part of the signal using a decode processing circuit; and
activation signal output means for outputting an activation signal for activating a microcontroller whose power is cut off, after the recognition by the signal recognition means.
